(19) United States
(12) Patent Application Publication
(10) Pub. No.: US 2015/0011697 A1
(43) Pub. Date: Jan. 8, 2015

(54) MELT-PROCESSIBLE VINYL FLUORIDE INTERPOLYMERS OF LOW CRYSTALLINITY

(71) Applicant: E I DU PONT DE NEMOURS AND COMPANY, Wilmington, DE (US)

(72) Inventors: Michael Joseph BROWN, Wilmington, DE (US); Vinci Martinez FELIX, Kennett Square, PA (US); Mookkan PERIYASAMY, Wilmington, DE (US); Ronald Earl USCHOLD, West Chester, PA (US)

(21) Appl. No.: 14/314,122

(22) Filed: Jun. 25, 2014

Related U.S. Application Data
(60) Provisional application No. 61/842,426, filed on Jul. 3, 2013.

(51) Int. Cl. C08F 214/28; C09D 127/20; C09D 5/03; C09D 127/18; C08F 214/26; C09D 5/08

(52) U.S. Cl. CPC C08F 214/282; C08F 214/262; C09D 5/08; C09D 5/03; C09D 127/18; C09D 127/20
USPC 524/546; 526/247

(57) ABSTRACT

In a first aspect, a melt-processible interpolymer consists essentially of units derived from vinyl fluoride and at least two highly fluorinated monomers, at least one of the highly fluorinated monomers introducing into the polymer a side chain of at least one carbon atom. The interpolymer has a melt flow rate in a range of from about 2 to about 250 grams per 10 minutes at a temperature of 280° C.

In a second aspect, an emulsion polymerization process for preparing a melt-processible interpolymer includes polymerizing vinyl fluoride and at least two highly fluorinated monomers in water with a water-soluble free-radical initiator at a temperature in the range of from about 60 to about 100° C. and a pressure in the range of from about 1 to about 12 MPa.

### BACKGROUND INFORMATION

1. Field of the Disclosure

This disclosure is in the field of fluorinated polymers containing melt-processible vinyl fluoride interpolymers of low crystallinity, and their preparation.

2. Description of the Related Art

Polyvinyl fluoride (PVF) has been manufactured for many years and has found many uses as a film or coating over a variety of substrates. For example, PVF has been incorporated into backsheets for photovoltaic modules, where it provides superior weatherability, mechanical, electrical and barrier properties. The fluorine atoms in PVF are largely responsible for these properties, and further enhancement of these properties may be achieved by incorporating monomers of higher fluorine content. One way to increase polymer fluorine content is to prepare copolymers in which tetrafluoroethylene (TFE) replaces some of the vinyl fluoride (VF). Such dipolymers have been described by Coffman and Ford, U.S. Pat. No. 2,419,009 (1947); Sianesi and Caporiccio, J. Polymer Sci., Part A-1, 6, (1968) 335, and U.S. Pat. No. 3,513,116 (1970). Another way is reported in Stilmar, U.S. Pat. No. 3,531,441 (1970), which describes the preparation of tri- and tetra-polymers, comprised of VF, TFE and a vinylidene monomer having neither an aromatic group nor a halogen group attached to the vinylidene group, in non-aqueous media. More recently, vinyl fluoride copolymers and vinyl fluoride interpolymers with low crystallinity have been described by Uschold in U.S. Pat. No. 6,242,547 (2001), U.S. Pat. No. 6,271,303 (2001), and U.S. Pat. No. 6,403,740 (2002). Uschold, in U.S. Pat. No. 6,242,547, proposes an interpolymer comprised of VF and at least two highly fluorinated monomers wherein at least one of the highly fluorinated monomers introduces a side chain, having at least one carbon atom, into the polymer. Such an interpolymer dissolves easily in some organic solvents because of decreased crystallinity. A film obtained from this interpolymer has low surface tension.

However, in the VF copolymers previously prepared, as fluorine content in the VF copolymer increases, the resulting resin tends to have lower intermolecular forces (intermolecular cohesive energy) and lower critical surface tension resulting in reduced adhesion to substrates. In addition, in order to improve processibility, it is necessary to reduce the crystallinity or molecular weight of the VF copolymer. Furthermore, polymers with a high VF content have not previously been processed from the melt (e.g., molded) because the thermal decomposition of PVF occurs at its melting point of about 200° C.

### SUMMARY

In a first aspect, a melt-processible interpolymer consists essentially of units derived from vinyl fluoride and at least two highly fluorinated monomers, at least one of the highly fluorinated monomers introducing into the polymer a side chain of at least one carbon atom. The interpolymer has a melt flow rate in a range of from about 2 to about 250 grams per 10 minutes at a temperature of 280° C.

In a second aspect, an emulsion polymerization process for preparing a melt-processible interpolymer includes polymerizing vinyl fluoride and at least two highly fluorinated monomers in water with a water-soluble free-radical initiator at a temperature in the range of from about 60 to about 100° C. and a pressure in the range of from about 1 to about 12 MPa. The vinyl fluoride and the at least two highly fluorinated monomers are employed in amounts which produce an interpolymer with a melt flow rate in a range of from about 2 to about 250 grams per 10 minutes at a temperature of 280° C. The polymerizing is carried out in an autoclave.

The foregoing general description and the following detailed description are exemplary and explanatory only and are not restrictive of the invention, as defined in the appended claims.

### DETAILED DESCRIPTION

### Definitions

The following definitions are used herein to further define and describe the disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “a” and “an” include the concepts of “at least one” and “one or more than one”.

Unless stated otherwise, all percentages, parts, ratios, etc., are by weight.

When the term “about” is used in describing a value or an end-point of a range, the disclosure should be understood to include the specific value or end-point referred to.

In the present application, the terms “sheet”, “layer” and “film” are used in their broad sense interchangeably. A “backsheet” is a sheet, layer or film on the side of a photovoltaic module that faces away from a light source, and is generally opaque. A “frontsheet” is a sheet, layer or film on the side of a photovoltaic module that faces a light source, and is generally transparent.

In a first aspect, a melt-processible interpolymer consists essentially of units derived from vinyl fluoride and at least two highly fluorinated monomers, at least one of the highly fluorinated monomers introducing into the polymer a side chain of at least one carbon atom. The interpolymer has a melt flow rate in a range of from about 2 to about 250 grams per 10 minutes at a temperature of 280° C.

In one embodiment of the first aspect, the interpolymer consists essentially of units derived from about 20 to about 60 mol % vinyl fluoride and about 10 to about 60 mol % of at least one C₂ olefin selected from the group consisting of vinylidene fluoride, tetrafluoroethylene, trifluoroethylene, and chlorotrifluoroethylene, and about 1 to about 20 mol % of a highly fluorinated monomer which introduces into the polymer a side chain of at least one carbon atom. In a more specific embodiment, the highly fluorinated monomer which introduces into the polymer a side chain of at least one carbon atom is selected from the group consisting of highly fluorinated vinyl ethers, perfluoroolefins having 3 to 10 carbon atoms, perfluoroC₁-C₈alkyl ethylenes and fluorinated dioxoles.

In another embodiment of the first aspect, the melt-processible interpolymer consists essentially of vinyl fluoride, tetrafluoroethylene and a perfluoroolefin of 3 to 10 carbon atoms. In a more specific embodiment, the perfluoroolefin is hexafluoropropylene.

In yet another embodiment of the first aspect, the melt-processible interpolymer consists essentially of vinyl fluoride, tetrafluoroethylene and a perfluoroC₁-C₈alkyl ethylene. In a more specific embodiment, the perfluoroC₁-C₈alkyl ethylene is perfluorobutyl ethylene.

In still another embodiment of the first aspect, the melt-processible interpolymer consists essentially of vinyl fluoride, tetrafluoroethylene, and a perfluoro(alkyl vinyl ether). The perfluoro(alkyl vinyl ether) has an alkyl group with 1 to 8 carbon atoms. In a more specific embodiment, the perfluoro(alkyl vinyl ether) is perfluoro(ethyl vinyl ether).

In still yet another embodiment of the first aspect, the melt-processible interpolymer includes a blend of the interpolymer with about 60 to about 99% by weight of polyvinyl fluoride.

In a further embodiment of the first aspect, the melt-processible interpolymer is a substantially random interpolymer.

In another embodiment of the first aspect, the melt-processible interpolymer further includes ionic end groups.

In a second aspect, an emulsion polymerization process for preparing a melt-processible interpolymer includes polymerizing vinyl fluoride and at least two highly fluorinated monomers in water with a water-soluble free-radical initiator at a temperature in the range of from about 60 to about 100° C. and a pressure in the range of from about 1 to about 12 MPa. The vinyl fluoride and the at least two highly fluorinated monomers are employed in amounts which produce an interpolymer with a melt flow rate in a range of from about 2 to about 250 grams per 10 minutes at a temperature of 280° C. The polymerizing is carried out in an autoclave.

In one embodiment of the second aspect, the autoclave is a horizontal autoclave.

In another embodiment of the second aspect, the polymerizing further comprises a chain transfer agent. In a more specific embodiment, the chain transfer agent is a low molecular weight aliphatic hydrocarbon or a lower alcohol. In one still more specific embodiment, the low molecular weight aliphatic hydrocarbon is selected from the group consisting of ethane, propane, butane and isobutane. In another still more specific embodiment, the lower alcohol is selected from the group consisting of methanol, ethanol, propanol and isopropanol.

In yet another embodiment of the second aspect, the temperature of the emulsion polymerization is in the range of from about 80 to about 100° C.

In still another embodiment of the second aspect, the pressure is in the range of from about 2.1 to about 8.3 MPa, or about 2.8 to about 4.1 MPa.

In a third aspect, a corrosion resistant coating includes a melt-processible interpolymer. The melt-processible interpolymer consists essentially of units derived from vinyl fluoride and at least two highly fluorinated monomers, at least one of the highly fluorinated monomers introducing into the polymer a side chain of at least one carbon atom. The interpolymer has a melt flow rate in a range of from about 2 to about 250 grams per 10 minutes at a temperature of 280° C.

In a fourth aspect, a dry sprayable powder includes a melt-processible interpolymer. The melt-processible interpolymer consists essentially of units derived from vinyl fluoride and at least two highly fluorinated monomers, at least one of the highly fluorinated monomers introducing into the polymer a side chain of at least one carbon atom. The interpolymer has a melt flow rate in a range of from about 2 to about 250 grams per 10 minutes at a temperature of 280° C.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

The present invention is directed to terpolymers and higher melt-processible interpolymers, consisting essentially of units derived from vinyl fluoride and at least two highly fluorinated monomers, at least one of the highly fluorinated monomers introducing into the polymer a side chain of at least one carbon atom. For the purposes of the present invention, “consists essentially of” means that, while the melt-processible interpolymer may contain other monomer units, the significant properties of the melt-processible interpolymer are determined by the named monomer units. In one embodiment, a melt-processible interpolymer composition comprises from about 20 to about 60 mol % vinyl fluoride; about 10 to about 60 mol % of at least one C₂ olefin selected from the group consisting of vinylidene fluoride, tetrafluoroethylene, trifluoroethylene, and chlorotrifluoroethylene; and about 1 to about 20 mol % of at least one highly fluorinated monomer which introduces into the polymer a side chain of at least one carbon atom. In another embodiment, a melt-processible interpolymer comprises from about 25 to about 45 mol % vinyl fluoride, about 40 to about 60 mol % of the C₂ olefin and about 1.5 to about 15 mol % of the highly fluorinated monomer.

In one embodiment, highly fluorinated monomers, which introduce into the polymer a side chain of at least one carbon atom, include perfluoroolefins having 3 to 10 carbon atoms, highly fluorinated olefins such as CF₃CY═CY₂ where Y is independently H or F, perfluoroC₁-C₈alkyl ethylenes, fluorinated dioxoles, and fluorinated vinyl ethers of the formula CY₂═CYOR or CY₂═CYOR′OR wherein Y is H or F, and —R and —R′ are independently completely-fluorinated or partially-fluorinated alkyl or alkylene group containing 1 to 8 carbon atoms, and in some embodiments are perfluorinated. In one embodiment, —R groups contain 1 to 4 carbon atoms, and in some embodiments are perfluorinated. In one embodiment, —R′— groups contain 2 to 4 carbon atoms, and in some embodiments are perfluorinated. In one embodiment, Y is F. For the purposes of the present disclosure, highly fluorinated is intended to mean that 50% or greater of the atoms bonded to carbon are fluorine, excluding linking atoms such as O or S.

In some embodiments, highly fluorinated monomers are perfluoroolefins, such as hexafluoropropylene (HFP); partially hydrogenated propenes such as 2,3,3,3-tetra perfluoropropene and 1,3,3,3-tetrafluoropropene; perfluoroC₁-C₈alkyl ethylenes, such as perfluorobutyl ethylene (PFBE); or perfluoro(C₁-C₈alkyl vinyl ethers), such as perfluoro(ethyl vinyl ether) (PEVE). Fluorinated dioxole monomers include perfluoro-2,2-dimethyl-1,3-dioxole (PDD) and perfluoro-2-methylene-4-methyl-1,3-dioxolane (PMD). Hexafluoroisobutylene is another highly fluorinated monomer useful in some embodiments.

Control of molecular weight is an important feature of melt-processible polymers to ensure that the polymer melt rheology is compatible with the melt process being used. For example, the melt flow rate (MFR) for the polymer should be controlled to be useful for extrusion or injection molding operations. Too low of a MFR will lead to melt fracture of the extrudate, or excessively high pressures to fill a mold, and render the material unusable. Too high of a MFR will produce extrudates or moldings with poor physical properties leading to poor quality materials. The MFR of vinyl fluoride melt-processible interpolymers may be controlled by the addition of a chain transfer agent to the monomer mixture charged to the reactor before polymerization is initiated. Suitable chain transfer agents are low molecular weight aliphatic hydrocarbons, such as ethane, propane, butane or isobutane; or lower alcohols such as methanol, ethanol, propanol or isopropanol. Control of MFR is governed by the amount of chain transfer agent added to the reactor. In one embodiment, as the concentration of ethane increases, relative to the monomer precharge ratio, the MFR increases. Interpolymer MFR is controlled by the ethane/monomer ratio. In one embodiment, melt-processible interpolymers have a MFR in the range of from about 2 to about 250 grams per 10 minutes at a temperature of 280° C., as determined by the method described herein below. In a particular embodiment, melt-processible interpolymers have a MFR in the range of about 10 to about 200 g/10 min at a temperature of 280° C. In a more particular embodiment, melt-processible interpolymers have a MFR in the range of about 20 to about 100 g/10 min at a temperature of 280° C. In some embodiments, melt-processible interpolymers are substantially random interpolymers. The substantially random character of the polymer is indicated by nuclear magnetic resonance spectroscopy.

By adding a termonomer having a side chain of at least one carbon atom, polymer compositions exhibit lower melting points and heats of fusion than unmodified compositions. Bulky side groups on the terpolymer hinder formation of a crystalline lattice structure. For example in comparing modified terpolymers to copolymers such as VF/TFE where the copolymer and the terpolymer have the same [VF]/[TFE] ratio, reduced crystallinity of the terpolymer is observed. As a consequence, films made from terpolymers disclosed herein have substantially reduced haze.

Melt-processible vinyl fluoride interpolymers can be produced in aqueous or nonaqueous media using the initiators, reaction temperatures, reaction pressures and general processes described by Coffman and Ford; Sianesi and Capriccio, or Stilmar in the references cited above. In one embodiment, the melt-processible vinyl fluoride interpolymers disclosed herein can be produced in a process which introduces ionic end groups into the polymer. The melt-processible interpolymers with such end groups are advantageously prepared by polymerizing VF and a fluorinated monomer in water with a water-soluble free-radical initiator at a temperature in the range of from about 60 to about 100° C., or about 80 to about 100° C., and a reactor pressure in the range of from about 1 to about 12 MPa (about 145 to about 1760 psi), or about 2.1 to about 8.3 MPa (about 305 to about 1204 psi), or about 2.8 to about 4.1 MPa (about 406 to about 595 psi). In one embodiment, the polymerization can be carried out in a horizontal autoclave. In another embodiment, the polymerization can be carried out in a vertical autoclave.

The initiators form ions upon dissolution in aqueous medium, and they introduce ionic end groups into the terpolymers produced. These end groups are derived from initiator fragments which begin the polymerization process. The amount of ionic end groups present in the polymer product is generally not more than 0.05 weight %. Small spherical particles may be formed that remain well dispersed in water because of the electrostatic charge on the particle surface arising from the ionic end groups. The electrostatic charge on the particles causes them to repel one another and keeps them suspended in water producing low viscosity terpolymer lattices. As a consequence, the lattices are fluid and stable enough to be pumped through equipment, making the polymerization process easy to operate and control, and produce aqueous dispersions of the melt-processible interpolymers. In one embodiment, the viscosity of the dispersions is less than 500 centipoises (0.5 Pa·s). In one embodiment, compositions comprise from about 5 to about 40%, or about 15 to about 30% by weight of terpolymer and about 60 to about 95%, or about 70 to about 85% by weight of water. Such dispersions can be made more concentrated if desired using techniques which are known in the art.

Initiators useful in manufacturing melt-processible interpolymer disclosed herein are water-soluble free-radical initiators such as water-soluble organic azo compounds such as azoamidine compounds which produce cationic end groups or water-soluble salts of inorganic peracids which produce anionic end groups. In one embodiment, organic azoamidine initiators include 2,2′-azobis(2-amidinopropane)dihydrochloride and 2,2′-azobis(N,N′-dimethyleneisobutyroamidine)dihydrochloride. In one embodiment, water-soluble salts of inorganic peracids include alkali metal or ammonium salts of persulfate.

For example, 2,2′-azobis(2-amidinopropane)dihydrochloride produces a terpolymer with an amidinium ion as an end group and yields terpolymer particles with a positive or cationic charge. Similarly, 2,2′-azobis(N,N′-dimethyleneisobutyroamidine)dihydrochloride produces a terpolymer with an N,N′-dimethyleneamidinium ion as an end group and yields positively charged or cationic particles. Persulfate initiators place sulfate end groups on the interpolymers which yield negatively charged or anionic particles.

Optionally, as well known to those skilled in the art of emulsion polymerization, additional ingredients may be added to the polymerization medium to modify the basic emulsion process. For example, surfactants compatible with the end groups of the polymer are advantageously employed. For instance, perfluorohexylpropylamine hydrochloride is compatible with the cationic end groups present in polymer initiated by bisamidine dihydrochloride; or ammonium perfluorooctanoate or perfluorohexylethane sulfonic acid or its salts can be used with the polymer having anionic end groups initiated by persulfate salts. As known in the art, reducing agents such as bisulfites, sulfites and thiosulfates can be used with persulfates to lower initiation temperatures or modify the structure of the polymer ionic end group. Buffering agents, such as phosphates, carbonates, acetates and the like, can be used with persulfate initiators to control latex pH. In some embodiments, initiators are the azobisamidine dihydrochlorides and ammonium persulfate used in combination with a surfactant, since they produce the whitest terpolymers and permit high aqueous dispersion solids.

The presence of the amidine hydrochloride end groups in the terpolymers disclosed herein is evident from their infrared spectra. The amidine hydrochloride end group in 2,2′-azobis(2-amidinopropane)dihydrochloride absorbs at 1680 cm⁻¹. The presence of this end group in the terpolymers is confirmed by the appearance of a band in their infrared spectra at 1680 cm⁻¹. Carboxyl and hydroxyl end groups are produced in polymers made with persulfate by hydrolysis of the sulfate end groups to yield fluoroalcohols that spontaneously decompose to form carboxylic end groups, or nonfluoroinated alcohols if the sulfate end group happens to be on a nonfluorinated carbon. The presence of these end groups is observed by bands in the infrared spectrum of these polymers at 1720 cm⁻¹ and 3526 cm⁻¹ for the carbonyl and hydroxyl structures, respectively.

Polymers with nonionic phenyl end groups prepared by the method of Coffman and Ford produce interpolymer particles which vary in size from submicrometer to greater than 10 μm. The particles have irregular shapes and often contain channels and voids.

Vinyl fluoride interpolymer compositions can be used to make high quality protective films and coatings with minimal haze on a wide variety substrates such as metal, plastic, ceramic, glass, concrete, fabric and wood. Conventional techniques for producing such films using non-melt-processible vinyl fluoride interpolymers include wet methods, such as casting, dipping, spraying and painting. In these methods, films are deposited as wet dispersions or solutions and subsequently dried and coalesced thermally. These wet methods, however, depend on organic solvents and require resin particle sizes in the submicron range to prepare suitable coating dispersions. Processing the dispersions requires milling to assure the small particle sizes, and high temperature ovens to dry the dispersions and coalesce the resin into a high quality film. For reasons of economy and the environment, the spent solvents must be recovered after the film is cast and refined to be reused. All this adds cost to film manufacture. Much of this cost and environmental impact is eliminated by using melt-processible resins. In addition, these wet coating methods are not conducive to forming molded articles of vinyl fluoride interpolymers.

In one embodiment, melt-processible vinyl fluoride interpolymer resins may be melt-extruded into film, tubing, or other shaped articles without the use of organic solvents. In another embodiment, organic solvents may be used with melt-processible vinyl fluoride interpolymers to form dispersions that may be used in wet coating processes. In still another embodiment, melt-processible vinyl fluoride interpolymers are also suitable for preparing dry sprayable powder coatings, for example, by spray drying melt-processible resins from an aqueous dispersion to produce powder particles that can then be electrostatically sprayed as a dry powder onto a substrate and fused to form a uniform coating. Alternatively, films can be melt-cast and laminated to a substrate with the aid of an adhesive or compression molded into various shapes.

In one embodiment, co-extrusion of melt-processible vinyl fluoride interpolymer compositions can be performed to form multilayer film, tubing or parts with other melt-processible resins. For example, a layer of vinyl fluoride interpolymer can be co-extruded with a layer of polyester to form a bi-layer film or tubing of vinyl fluoride interpolymer with polyester. In other embodiments, three or more layers can be co-extruded to form multilayer film or tubing. Conventional extrusion processes, such as cast extrusion through a flat or shaped die or tubular blown film, or both cast and tubular co-extrusions can be used to form multilayer film or tubing. The vinyl fluoride copolymer can be melt processed under similar conditions as conventional co-extrudable adhesives (e.g. Bynel® resin from DuPont or structural materials such as polyolefins or nylons).

In one embodiment, mechanical, optical and/or barrier properties of film, including tensile strength and modulus of elasticity, may be improved by stretching, or orienting, the film. The term “oriented”, as used herein, refers to an orientation process, under which a polymeric film or sheet is uni-axially or bi-axially stretched in the transverse direction (TD) and/or machine direction (MD). Stretching apparatus and processes to obtain uni-axially or bi-axially oriented films or sheets are known in the art and may be adapted by those skilled in the art to produce the films or sheets disclosed herein. Examples of such apparatus and processes include, for example, those disclosed in U.S. Pat. Nos. 3,278,663; 3,337,665; 3,456,044; 4,590,106; 4,760,116; 4,769,421; 4,797,235; and 4,886,634. For uni-axial orientation, an extruded film, in the form of a continuous web, may be passed over heated rollers to raise the temperature of the film to the necessary stretching temperature, and then by adjusting the speeds of the subsequent rollers, the film can be stretched in the machine direction. For bi-axial orientation, a film, once again in the form of a continuous web, may be stretched either sequentially using rollers for machine direction stretching and a tenter frame for transverse stretching, or simultaneously in an appropriately equipped tenter to properly orient the film and thereby improve its properties. In a third technique for bi-axial orientation, the stretching operation may be carried out by extruding film in tubular form and stretching in an appropriate apparatus using a combination of tubular expansion and machine-direction stretching techniques.

In some embodiments, films of the melt-processible interpolymers have low surface tensions making them valuable for items such as release sheets and films, mold release sprays, and lubricants. They may be used to confer soil release properties to articles such as wall panels, fabrics and carpets. In one embodiment, melt-processible interpolymers can be blended with about 60 to about 99% by weight of polyvinyl fluoride, or about 80 to about 95% by weight of polyvinyl fluoride.

Melt-processible vinyl fluoride interpolymer may be used in a broad range of applications where improved UV resistance, permeation resistance, chemical resistance and/or lower surface tension are desired. In addition to films for photovoltaic backsheets or frontsheets, melt-processible vinyl fluoride interpolymers may be used as architectural films, weather-resistant and anti-graffiti signage, automotive tubing (e.g., fuel hoses), corrosion resistant coatings (e.g., tank and tube linings for the chemical process industry), in electronic applications (e.g., wire insulation, cable jackets, etc.) and as polymer processing aids. In one embodiment of a polymer processing aid, the melt-processible vinyl fluoride interpolymer can be added at low percentages (typically less than 1% by weight) to high viscosity polymers such as linear low-density polyethylene, high-density polyethylene or nylon, to reduce head pressure and/or melt fracture and increase extruder throughput. Those skilled in the art will appreciate the wide variety of applications where melt-processible vinyl fluoride interpolymers may be used.

In one embodiment, for a corrosion resistant coating, a melt-processible interpolymer may be blended with an adhesive, such as polymethyl methacrylate (PMMA), and applied as a dispersion to a substrate (e.g., a metal substrate). The dispersion may include organic solvents that act both as a dispersant for the melt-processible interpolymer and a solvent for the adhesive. For example, a mixture of isophorone and toluene may be used to dissolve PMMA before adding a melt-processible interpolymer to form a dispersion. In one embodiment, other additives, such as pigments, light stabilizers and other fillers may be included in the dispersion. The dispersion may then be applied to a substrate, such as an aluminum panel, using a wet coating technique, such as spray coating, and cured at an elevated temperature to form a uniform coating. In one embodiment, the coating process may be repeated one or more times to build a coating of the desired thickness.

### Test Methods

### Polymer Composition

Polymer composition was determined by 19F-NMR measuring the spectrum at 235.4 MHz of each polymer dissolved in dimethylacetamide at 130° C. Integration of signals near −80 ppm arising from CF₃ groups was used to measure the amount of hexafluoropropylene (HFP). Integration of complex sets of signals from −105 to −135 ppm for CF₂ groups from TFE units in the terpolymer, corrected for the CF₂ content contributed by any other monomer, and from −150 to −220 ppm for CHF groups from the VF units in the terpolymer corrected for the CF content contributed by any other monomer when present provided complete compositional data for each sample. Infrared spectroscopy was used to identify the presence of ionic end groups.

### Melt Flow Rate

Melt Flow Rate (MFR) or melt index was used as a measure of molecular weight and was measured with a D4002 Melt Indexer (Danisco, Franklin, Mass.) using a 5 minute preheat at 280° C. Samples were extruded using a 0.0825″ diameter by 0.31″ long orifice and a 5 kg weight. Five replicate samples were cut at measured time intervals and accurately weighed. The amount of material that would be extruded in 10 minutes was calculated for each cut and averaged with the other measurements. The result is reported as MFR.

### Melting Point

Melting points were measured in air using a Q20 Differential Scanning calorimeter (DSC) (TA Instruments, New Castle, Del.). Because the thermal history of the sample can affect the measurement of Tₘ, samples were heated to 250° C. at 10° C./min, then cooled and reheated at 10° C./min. The peak temperature of the endotherm observed during the reheat of the sample is reported as Tₘ.

### Heat of Fusion

Heat of fusion of the polymer was determined by integrating the area under the melting endotherm recorded by the DSC and is reported as ΔHf in J/g.

### EXAMPLES

### Synthesis of Melt-Processible Copolymers

A horizontal stainless steel autoclave of 11.3 L (3 US gallons) or 37.8 L (10 US gallons) capacity equipped with a stirrer and a jacket was used as a polymerization reactor. Instruments for measuring temperature and pressure and a compressor for supplying the monomer mixtures to the autoclave at a desired pressure were attached to the autoclave.

The autoclave was filled with deionized water containing perfluoro-2-propoxypropanoic acid (DA) and Krytox® 157FSL (DuPont Co., Wilmington, Del.) neutralized with ammonium hydroxide to reach a pH in the range of about 7-8, to 70 to 80% of its capacity, and was followed by increasing the internal temperature to 90° C. The amounts of these materials (in grams) and the reactor volume for each example are given in Table 1. For comparative examples CE1 and CE2, ammonium perfluorooctanoate (APFO 12 or APFO 14) were used instead of DA. The autoclave was subsequently purged of air by pressurizing three times to 2.8 MPa (400 psig) using nitrogen. After purging, ethane was optionally introduced into the autoclave, which was then precharged with the monomer mixtures, having the compositions shown in Table 1, until the internal pressure reached 2.8 MPa (400 psig).

TABLE 1

| Exam- | Reactor | | | | | | Krytox ® |
|---|---|---|---|---|---|---|---|
| ple | (gal) | TFE | VF | HFP | Ethane | DA | 157FSL |
| CE1 | 3 | 123.3 | 215.8 | 277.5 | 0 | APFO 12 | 0 |
| CE2 | 3 | 116.0 | 203.0 | 261.0 | 0 | APFO 14 | 0 |
| E1 | 10 | 856.6 | 95.2 | 951.8 | 40 | 500 | 41.0 |
| E2 | 10 | 867.8 | 96.4 | 964.3 | 35 | 500 | 41.0 |
| E3 | 10 | 868.1 | 96.5 | 964.5 | 35 | 500 | 41.0 |
| E4 | 10 | 852.5 | 94.7 | 947.3 | 40 | 500 | 41.0 |
| E5 | 3 | 380.9 | 42.3 | 423.2 | 5 | 42.7 | 3.08 |
| E6 | 3 | 327.3 | 36.4 | 363.7 | 15 | 42.7 | 3.08 |
| E7 | 3 | 309.2 | 34.4 | 343.5 | 20 | 42.7 | 3.08 |
| E8 | 3 | 321.9 | 35.8 | 357.7 | 17 | 42.7 | 3.08 |
| E9 | 3 | 324.8 | 36.1 | 360.8 | 17 | 42.7 | 3.08 |
| E10 | 3 | 337.7 | 37.5 | 375.2 | 17 | 42.7 | 3.08 |
| E11 | 10 | 785.0 | 96.9 | 872.2 | 100 | 110 | 10 |
| E12 | 10 | 785.0 | 96.9 | 872.2 | 50 | 110 | 10 |
| E13 | 10 | 641.3 | 79.2 | 712.5 | 75 | 110 | 10 |
| E14 | 10 | 615.4 | 76.0 | 683.8 | 75 | 110 | 10 |
| E15 | 10 | 641.3 | 79.2 | 712.5 | 60 | 110 | 10 |
| E16 | 10 | 643.7 | 79.5 | 715.2 | 57 | 110 | 10 |
| E17 | 10 | 644.3 | 79.5 | 715.8 | 57 | 110 | 10 |
| E18 | 10 | 643.5 | 79.4 | 715.0 | 55 | 110 | 10 |
| E19 | 10 | 647.0 | 78.9 | 718.9 | 57 | 110 | 10 |
| E20 | 10 | 656.3 | 81.0 | 729.2 | >57 | 110 | 10 |
| E21 | 10 | 647.9 | 80.0 | 719.9 | 57 | 110 | 10 |
| E22 | 10 | 650.7 | 80.3 | 723.0 | 57 | 110 | 10 |

An initiator solution was prepared by dissolving 10 g ammonium persulfate (APS) into 1 L of deionized water. When using a 3 gallon reactor, the initiator solution was supplied into the reactor with an initial feed of 25 ml, then fed at the rate of 1 ml/min during the reaction. When using a 10 gallon reactor, the initiator solution was supplied into the reactor with an initial feed of 80 ml, then fed at the rate of 3 ml/min during the reaction.

When the internal pressure of the reactor began to drop, makeup monomer mixtures shown (in grams) in Table 2 were supplied to keep the pressure constant at 2.8 MPa (400 psig).

TABLE 2

| | Reactor | | | |
|---|---|---|---|---|
| Example | (gal) | TFE | VF | HFP |
| CE1 | 3 | 558.0 | 781.1 | 255.1 |
| CE2 | 3 | 770.0 | 1078.3 | 352.1 |
| E1 | 10 | 3510.0 | 1080.0 | 810.0 |
| E2 | 10 | 3510.4 | 1080.1 | 810.1 |
| E3 | 10 | 3510.4 | 1080.1 | 810.1 |
| E4 | 10 | 3510.3 | 1080.1 | 810.1 |
| E5 | 3 | 1820.0 | 560.0 | 420.0 |
| E6 | 3 | 1820.0 | 560.0 | 420.0 |
| E7 | 3 | 1820.0 | 560.0 | 420.0 |
| E8 | 3 | 1820.0 | 560.0 | 420.0 |
| E9 | 3 | 1820.0 | 560.0 | 420.0 |
| E10 | 3 | 1820.0 | 560.0 | 420.0 |
| E11 | 10 | 5265.0 | 1620.0 | 1215.0 |
| E12 | 10 | 5265.0 | 1620.0 | 1215.0 |
| E13 | 10 | 5265.0 | 1620.0 | 1215.0 |
| E14 | 10 | 5265.0 | 1620.0 | 1215.0 |
| E15 | 10 | 5265.0 | 1620.0 | 1215.0 |
| E16 | 10 | 5265.0 | 1620.0 | 1215.0 |
| E17 | 10 | 5265.0 | 1620.0 | 1215.0 |
| E18 | 10 | 5265.0 | 1620.0 | 1215.0 |
| E19 | 10 | 5265.0 | 1620.0 | 1215.0 |
| E20 | 10 | 5265.0 | 1620.0 | 1215.0 |
| E21 | 10 | 5265.0 | 1620.0 | 1215.0 |
| E22 | 10 | 5265.6 | 1620.2 | 1215.1 |

The composition of the makeup monomer mixture is different from that of the precharge mixture because of the different reactivity of each monomer. Since each composition is selected so that the monomer composition in the reactor is kept constant, a product having a uniform composition was obtained.

Monomers were supplied to the autoclave until a solid content in the produced latex reached about 20-30%. When the solid content reached a predetermined value, supply of the monomers was immediately stopped, then the contents of the autoclave were cooled and unreacted gases in the autoclave were purged off.

To the resulting latex, 15 g of ammonium carbonate dissolved in water per 1 L of latex and then 70 mL of HFC-4310 (1,1,1,2,3,4,4,5,5,5-decafluoropentane) per 1 L of latex were added while stirring at high speed, followed by isolation of the polymer by filtration. The polymer was washed with water and dried at 90 to 100° C. in a hot-air dryer. Compositions, melting points and heats of fusion of the produced polymers are shown in Table 3. For each example, two measurements were made for the melting point and heat of fusion.

TABLE 3

| | Polymer Comp | | | Sol- | Poly- | MFR | | |
|---|---|---|---|---|---|---|---|---|
| Exam- | (mol %) | | | ids | mer | (g/10 | Tm | ΔHf |
| ple | TFE | VF | HFP | (%) | (g) | min) | (° C.) | (J/g) |
| CE1 | 21.8 | 68.1 | 10.0 | 21.8 | 1823 | 0.0 | 175, 175 | 11 |
| CE2 | 21.3 | 69.4 | 9.3 | 27.4 | 2501 | 0.0 | 176, 176 | 19 |
| E1 | 54.4 | 37.6 | 8.0 | 22.2 | 5695 | 29.1 | 168, 174 | 25, 22 |
| E2 | 54.0 | 37.8 | 8.3 | 22.2 | 5715 | 21.2 | 166, 172 | 22, 21 |
| E3 | 54.1 | 38.2 | 7.7 | 21.9 | 5595 | 10.5 | 173, 172 | 22, 21 |
| E4 | 54.2 | 38.0 | 7.8 | 21.9 | 5601 | 17.7 | 173, 173 | 22, 21 |
| E5 | 54.2 | 36.7 | 9.1 | 30.1 | 2878 | 1.8 | 164, 160 | 13, 12 |
| E6 | 52.8 | 38.8 | 8.4 | 29.2 | 2737 | 47.4 | 165, 165 | 16, 15 |
| E7 | 53.7 | 37.9 | 8.4 | 27.5 | 2505 | 123.4 | 166, 166 | 16, 16 |
| E8 | 54.3 | 37.0 | 8.7 | 27.9 | 2585 | 69.2 | 166, 167 | 19, 17 |
| E9 | 55.0 | 36.5 | 8.5 | 28.2 | 2621 | 54.3 | 167, 167 | 17, 17 |
| E10 | 55.0 | 36.0 | 9.0 | 28.4 | 2659 | 61.7 | 166, 166 | 16, 16 |
| E11 | 53.7 | 39.1 | 7.2 | 31.0 | 8522 | 247.0 | 170, 174 | 24, 22 |
| E12 | 54.3 | 39.1 | 6.9 | 30.4 | 8304 | 21.3 | 175, 175 | 18, 21 |
| E13 | 52.2 | 40.3 | 7.4 | 31.5 | 8729 | 187.0 | 167, 170 | 15, 19 |
| E14 | 53.9 | 39.0 | 7.1 | 30.7 | 8420 | 207.0 | 168, 172 | 17, 22 |
| E15 | 53.9 | 39.0 | 7.1 | 31.1 | 8503 | 106.0 | 171, 174 | 16, 22 |
| E16 | 52.3 | 40.7 | 7.0 | 30.9 | 8498 | 87.6 | 171, 175 | 23, 23 |
| E17 | 53.0 | 39.5 | 7.4 | 30.3 | 8219 | 54.1 | 169, 172 | 21, 20 |
| E18 | 53.4 | 39.5 | 7.1 | 30.7 | 8375 | 61.8 | 170, 174 | 20, 22 |
| E19 | 53.4 | 39.2 | 7.3 | 31.0 | 8507 | 79.4 | 171, 174 | 22, 23 |
| E20 | 54.0 | 38.9 | 7.1 | 30.6 | 8382 | 195.0 | 171, 173 | 21, 23 |
| E21 | 52.9 | 39.8 | 7.3 | 30.7 | 8409 | 101.0 | 172, 174 | 20, 24 |
| E22 | 53.9 | 38.9 | 7.2 | 30.7 | 8411 | 91.0 | 172, 177 | 26, 24 |

To demonstrate that the chain transfer agent (e.g., ethane) controls MFR of the polymer, samples were melt pressed at 200° C. into films 0.008″ thick. The films were examined by infrared spectroscopy and the intensity of bands occurring at 3526 cm⁻¹, 2362 cm⁻¹ and 1724 cm⁻¹ were analyzed. The bands at 3256 cm⁻¹ and 1724 cm⁻¹ are due to the presence of hydroxyl and carboxyl groups in the film, respectively. The band at 2362 cm⁻¹ is an overtone from the C—F stretching vibrations in the polymer and was used to normalize the hydroxyl and carbonyl absorptions to correct for slight differences in film thickness film to film. Duplicate films of each sample were prepared. The normalized intensities, MFR for each polymer and ethane added to the polymerization to produce that polymer is reported in Table 4.

TABLE 4

| | C═O | OH | | |
|---|---|---|---|---|
| Example | intensity | intensity | MFR | ethane |
| E5 | 0.241 | 0.050 | 1.8 | 5 |
| E5 | 0.249 | 0.046 | 1.8 | 5 |
| E6 | 0.260 | 0.058 | 47.4 | 15 |
| E6 | 0.265 | 0.055 | 47.4 | 15 |
| E7 | 0.295 | 0.066 | 123.4 | 20 |
| E7 | 0.265 | 0.057 | 123.4 | 20 |

The results clearly indicate that MFR correlates with ethane content, showing that the controlled addition of a chain transfer agent is capable of regulating molecular weight and polymer melt viscosity. As the molecular weight decreases, an increase in end groups on the polymer is expected. Carboxyl groups are end groups formed during polymerizations with persulfate initiators by hydrolysis of the sulfate ends initially formed during the initiation process. The use of a chain transfer agent, such as ethane, stops growth of the polymer chain prematurely resulting in lower molecular weight. As a consequence, more end groups per unit weight of polymer are obtained. Examination of the infrared intensities reported in Table 4 show an increase as ethane and MFR increase.

### Corrosion Resistant Coating of Melt-Processible Interpolymer

For comparative example 3 (CE3), in a clean jar, 50 g methyl ethyl ketone (MEK) was added, followed by 24 g of melt-processible interpolymer (65 wt % TFE, 20 wt % VF and 15 wt % HFP). The jar was rolled for 30 minutes, followed by the addition of 16 g of TiO₂ (Ti-Pure® R-960, DuPont) and another 30 minutes of rolling. The dispersion viscosity was measured using a Brookfield DV-II+ Pro Viscometer (Brookfield Engineering Laboratories, Inc., Middleboro, Mass.) with a #3 spindle at 10 rpm. If the Brookfield viscosity was greater than 1000 centipoise (cps), the dispersion was diluted with MEK until the viscosity was below 1000 cps. The dispersion was homogenized using a high shear mixer (L5M-A, Silverson Machines, Inc., Chesham, UK)) for a maximum of 6-8 minutes with 2 minute rest intervals to minimize heat generation. The Brookfield Viscosity of the homogenized dispersion was measured again and diluted again with MEK to bring the viscosity below 1000 cps. The dispersion was kept rolling at slow speed until it was used for coating.

The dispersion was drawn down on chrome-treated aluminum panels (3×6 inches), and the aluminum panels were placed inside a preheated oven at 254° C. (490° F.). After reaching temperature, the panels were held in the oven for 45 seconds, water quenched for 1-2 minutes, and dried with a clean towel. The coating was repeated as needed to get the desired coating thickness in the range of about 15 to about 56 μm (about 0.6 to about 2.2 mil). Initial adhesion was checked using a rub test method, which involved rubbing the coated panels with heavy pressure using a dry paper towel.

For examples 23 and 24 (E23 and E24), the procedure of CE3 was followed, except that a blend of interpolymer and PMMA (Paraloid B-44, Dow Chemical Co., Midland, Mich.) was used. The PMMA was added to the jar with MEK and dissolved by rolling before adding the interpolymer. Table 5 shows the weight percents (based on total weight of polymer) used in these dispersions. While CE3 did not pass the initial adhesion test, both E23 and E24 did pass. All three dispersions had solids contents (combined weight of polymer and TiO₂) in the range of about 40 to about 50 weight percent.

TABLE 5

| | | | | Initial |
|---|---|---|---|---|
| Example | Interpolymer | PMMA | Solvent | Adhesion |
| CE3 | 100 | 0 | MEK | Fail |
| E23 | 90 | 10 | MEK | Pass |
| E24 | 80 | 20 | MEK | Pass |
| E25 | 70 | 30 | Isophorone/MEK (70/30) | Pass |
| E26 | 70 | 30 | Isophorone/Toluene | Pass |
| | | | (70/30) | |

For example 25 (E25), a weight ratio of interpolymer to PMMA of 70:30 was used, and MEK was replaced by a 70:30 wt % mixture of isophorone:MEK. In a clean jar, 35 g of isophorone and 15 g of toluene were added, followed by 10 g of PMMA. The jar was then rolled using an air driven roller at medium speed until the PMMA was fully dissolved. 24 g of melt-processible interpolymer was then added and the jar was rolled for 30 minutes, followed by the addition of 16 g of TiO₂ and another 30 minutes of rolling. For example 26 (E26), the procedure of E25 was followed, except that a 70:30 wt % mixture of isophorone:toluene was used as a solvent.

After homogenizing and reducing the viscosity to less than 1000 cps, the dispersions of E25 and E26 had solids contents (combined weight of polymer and TiO₂) in the range of about 40 to about 50 weight percent. These dispersions were spray coated onto chrome-treated aluminum panels. The spray coating was repeated as needed to get the desired coating thickness in the range of about 15 to about 56 μm (about 0.6 to about 2.2 mil). The coating of E26, using the isophorone/toluene mixture, produced a more uniform coating and dried with no cracks.

Both E25 and E26 passed the initial adhesion test, and were further tested quantitatively following the ASTM D3359-09 standard cross-hatch adhesion method using a Gardco® PA-2000 (Paul N. Gardner Co., Inc., Pompano Beach, Fla.). Both E25 and E26 passed the cross-hatch adhesion test, showing no lifting or breaks in the coatings on aluminum panels.

E25 and E26 were further tested for salt spray corrosion resistance in a Q-fog cyclic corrosion tester (CCT-600, Q-Panel Lab Products, Cleveland, Ohio). This machine has a large chamber fitted with slotted sample holders that hold the sample panels at an angle of about 15 degrees from vertical, with the coated side facing upward. The test itself is a variant of ASTM B117. The tester continuously atomizes a solution of 5% sodium chloride brine and introduces the mist into the sealed chamber with the samples. The mist circulates around the exposed samples, and any condensate runs off due to the angle of the panels. The entire chamber is maintained at a temperature of 35° C., and the samples are checked periodically. Both E25 and E26 survived 1500 hours in the tester, showing no evidence of failure, such as blisters under the coating or visible metal corrosion.

### Dry Sprayable Powder of Melt-Processible Interpolymer

For example 27 (E27), a 29.4 weight percent solids aqueous dispersion of melt-processible interpolymer (65 wt % TFE, 20 wt % VF and 15 wt % HFP) was spray dried using an S-28 spray dryer (GEA Process Engineering, Inc., Columbia, Md.) with a two-fluid nozzle at an air flow rate of 1960 kg/hr, with an atomizing air pressure of 0.66 MPa (95 psi) and 70% air flow. The inlet and outlet temperatures were 220 and 130° C., respectively. Powder particles having a bulk density in a range of from about 0.35 to about 0.40 g/cm³ and a D50 particle size in the range of from about 9 to about 13 μm (wet measurement using a Horiba LA-910 laser scattering particle size analyze) were obtained. The powder particles had residual moisture content in the range of from about 0.26 to about 0.64%.

This example demonstrates that a free-flowing powder with low residual moisture content can be made from an aqueous dispersion of melt-processible interpolymer using a commercial scale spray drying process.

Dry Sprayable Powder of Melt-Processible Interpolymer with TiO₂

For example 28 (E28), a 36.3 weight percent total solids aqueous dispersion of melt-processible interpolymer (30 wt %) and TiO₂ (6.3 wt %) was spray dried using a GEA Niro Mobile Minor™ MM-XP spray dryer (GEA Process Engineering, Inc.) with a two-fluid nozzle under nitrogen at a feed rate (dry) of 1.09 kg/hr, with an atomizing gas pressure of 1.1 bar (160 psi) and 78% gas flow. The inlet and outlet temperatures were 220 and 130° C., respectively. Powder particles having a bulk density of about 0.44 g/cm³ and a D50 particle size of about 4.6 μm (wet measurement using a Horiba LA-950 laser scattering particle size analyzer, Horiba Instruments, Ann Arbor, Mich.) were obtained. The powder particles had a residual moisture content of about 0.70%.

The non-segregatable nature of the sprayable powder of interpolymer with TiO₂ was demonstrated by comparing it to standard mechanically blended interpolymer with TiO₂. A mechanically mixed sample of interpolymer with TiO₂ was made using a mechanical mixer/tumbler to physically mix the interpolymer with TiO₂. Powders made using the spray drying process, as well as the mechanically mixed sample, are each poured into a 100 ml graduated cylinder up to the 50 ml level. Each sample is then poured into separate sample jars where 100 ml of water is added to each one. Each sample jar is sealed and each jar is shaken vigorously until all the particle clumps are dispersed. Each sample is then poured into separate 250 ml graduated cylinders and allowed to stand. After 10 minutes, the following parameters are observed: (1) the level of separated components and (2) the clearness or cloudiness of the aqueous phase. From this test it is observed that components from the samples prepared by mechanical mixing separate into distinct layers. In contrast, the sprayable powders are non-segregatable, i.e., there is little or no separation of the TiO₂ from the interpolymer. The TiO₂ is encapsulated in (or intimately enmeshed with) the interpolymer particles and do not tend to separate. The aqueous phase of sprayable powder tends to be clear.

This example demonstrates that a free-flowing powder with low residual moisture content can be made from an aqueous dispersion of melt-processible interpolymer and TiO₂.

### Oriented Films of Melt-Processible Interpolymer

For example 29 (E29), a sequential orientation process was used to stretch a melt-extruded film of melt-processible interpolymer (65 wt % TFE, 20 wt % VF and 15 wt % HFP) on a biaxial orientation system (Parkinson Technologies, Inc., Woonsocket, R.I.). Using a stretching ratio (MD×TD) of 2×4 and a line speed of from about 0.02 to about 0.03 meter per second (about 3.9 to about 6.0 feet per minute), biaxial films of from about 25.4 to about 29.5 μm (about 1.00 to about 1.16 mils) were made. After melt-extruding, the film is initially cooled to about 38° C. (100° F.) before heating to a temperature of about 65° C. (149° F.) for machine direction stretching and then annealed at a temperature of about 55° C. (131° F.). This is followed by heating to a temperature of about 48° C. (118° F.) for transverse direction stretching and annealing at a temperature of about 50° C. (122° F.) before cooling to room temperature.

The biaxially oriented film demonstrated significant improvement in mechanical properties over a cast film, comparative example 4 (CE4), that was melt-extruded under the same film forming conditions, but was not stretched in either direction. Improvements in yield point, yield stress and tensile break strength are summarized in Table 6.

TABLE 6

| | | | Improvement |
|---|---|---|---|
| Property | CE4 | E29 | (Increase) |
| MD Yield Point (%) | 4.49 | 147 | 33x |
| TD Yield Point (%) | 4.44 | 92.8 | 21x |
| MD Yield Stress (MPa) | 11.7 | 57.8 | 5x |
| TD Yield Stress (MPa) | 13.1 | 78.6 | 6x |
| MD Tensile Break Strength (MPa) | 24.0 | 57.8 | 2.4x |
| TD Tensile Break Strength (MPa) | 22.5 | 78.6 | 3.5x |

Note that not all of the activities described above in the general description or the examples are required, that a portion of a specific activity may not be required, and one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof has been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. Further, references to values stated in ranges include each and every value within that range.

What is claimed is:

1. A melt-processible interpolymer consisting essentially of units derived from vinyl fluoride and at least two highly fluorinated monomers, at least one of the highly fluorinated monomers introducing into the polymer a side chain of at least one carbon atom, wherein the interpolymer has a melt flow rate in a range of from about 2 to about 250 grams per 10 minutes at a temperature of 280° C.

2. The melt-processible interpolymer of claim 1, wherein the interpolymer consists essentially of units derived from about 20 to about 60 mol % vinyl fluoride and 10-60 mol % of at least one C₂ olefin selected from the group consisting of vinylidene fluoride, tetrafluoroethylene, trifluoroethylene, and chlorotrifluoroethylene, and from about 1 to about 20 mol % of a highly fluorinated monomer which introduces into the polymer a side chain of at least one carbon atom.

3. The melt-processible interpolymer of claim 2, wherein the highly fluorinated monomer which introduces into the polymer a side chain of at least one carbon atom is selected from the group consisting of highly fluorinated vinyl ethers, perfluoroolefins having 3 to 10 carbon atoms, perfluoroC₁-C₈alkyl ethylenes and fluorinated dioxoles.

4. The melt-processible interpolymer of claim 1 consisting essentially of vinyl fluoride, tetrafluoroethylene and a perfluoroolefin of 3 to 10 carbon atoms.

5. The melt-processible interpolymer of claim 4, wherein the perfluoroolefin is hexafluoropropylene.

6. The melt-processible interpolymer of claim 1 consisting essentially of vinyl fluoride, tetrafluoroethylene and a perfluoroC₁-C₈alkyl ethylene.

7. The melt-processible interpolymer of claim 6, wherein the perfluoroC₁-C₈alkyl ethylene is perfluorobutyl ethylene.

8. The melt-processible interpolymer of claim 1 consisting essentially of vinyl fluoride, tetrafluoroethylene, and a perfluoro(alkyl vinyl ether) wherein the perfluoro(alkyl vinyl ether) has an alkyl group with 1 to 8 carbon atoms.

9. The melt-processible interpolymer of claim 8, wherein the perfluoro(alkyl vinyl ether) is perfluoro(ethyl vinyl ether).

10. The melt-processible interpolymer of claim 1 comprising a blend of the interpolymer with about 60 to about 99% by weight of polyvinyl fluoride.

11. The melt-processible interpolymer of claim 1, wherein the interpolymer is a substantially random interpolymer.

12. The melt-processible interpolymer of claim 1 further comprising ionic end groups.

13. An emulsion polymerization process for preparing a melt-processible interpolymer comprising polymerizing vinyl fluoride and at least two highly fluorinated monomers in water with a water-soluble free-radical initiator at a temperature in the range of from about 60 to about 100° C. and a pressure in the range of from about 1 to about 12 MPa, wherein:
the vinyl fluoride and the at least two highly fluorinated monomers are employed in amounts which produce an interpolymer with a melt flow rate in a range of from about 2 to about 250 grams per 10 minutes at a temperature of 280° C.; and
the polymerizing is carried out in an autoclave.

14. The process of claim 13, wherein the autoclave is a horizontal autoclave.

15. The process of claim 13, wherein the polymerizing further comprises a chain transfer agent.

16. The process of claim 15, wherein the chain transfer agent is a low molecular weight aliphatic hydrocarbon or a lower alcohol.

17. The process of claim 16, wherein the low molecular weight aliphatic hydrocarbon is selected from the group consisting of ethane, propane, butane and isobutane.

18. The process of claim 16, wherein the lower alcohol is selected from the group consisting of methanol, ethanol, propanol and isopropanol.

19. The process of claim 13, wherein the temperature of the emulsion polymerization is in the range of from about 80 to about 100° C.

20. The process of claim 13, wherein the pressure is in the range of from about 2.1 to about 8.3 MPa, or about 2.8 to about 4.1 MPa.

21. A corrosion resistant coating comprising a melt-processible interpolymer, wherein the melt-processible interpolymer consists essentially of units derived from vinyl fluoride and at least two highly fluorinated monomers, at least one of the highly fluorinated monomers introducing into the polymer a side chain of at least one carbon atom, wherein the interpolymer has a melt flow rate in a range of from about 2 to about 250 grams per 10 minutes at a temperature of 280° C.

22. A dry sprayable powder comprising a melt-processible interpolymer, wherein the melt-processible interpolymer consists essentially of units derived from vinyl fluoride and at least two highly fluorinated monomers, at least one of the highly fluorinated monomers introducing into the polymer a side chain of at least one carbon atom, wherein the interpolymer has a melt flow rate in a range of from about 2 to about 250 grams per 10 minutes at a temperature of 280° C.
